(19) United States
(12) Patent Application Publication
(10) Pub. No.: US 2007/0091229 A1
(43) Pub. Date: Apr. 26, 2007

(54) Vertically aligned liquid crystal display

(76) Inventors: Soo Jin Jang, Seoul (KR); Byoung Kun Jeon, Daejeon Metropolitan City (KR); Jun Won Chang, Daejeon Metropolitan City (KR); Sang Choll Han, Daejeon Metropolitan City (KR); Dong Man Cho, Daejeon Metropolitan City (KR); Sung Hyun Nam, Daegu Metropolitan City (KR)

Correspondence Address: MCKENNA LONG & ALDRIDGE LLP;Song K. Jung, 1900 K Street, N.W., Washington, DC, 20006, US

(21) Appl. No.: 11/449,026

(22) Filed: Jun. 8, 2006

(30) Foreign Application Priority Data
Jun. 9, 2005 (KR) 2005-0049325

(51) Int. Cl. G02F 1/1335; G02F 1/1337

(52) U.S. Cl. 349/96; 349/130

(57) ABSTRACT

Disclosed herein is an integrated-type polarizer comprising a polarizing film provided with a biaxial retardation film as a protective film on a first side thereof, the polarizing film having an absorption axis perpendicular to the optical axis of the biaxial retardation film. Also is provided a vertically aligned liquid crystal display comprising a liquid crystal cell filled with liquid crystal molecules of negative dielectric anisotropy between a first and a second polarizer, the respective absorption axes of which are perpendicular to each other, wherein the integrated-type polarizer acts as the first polarizer.

### TECHNICAL FIELD

The present invention relates to a polarizer and a vertically aligned liquid crystal display (hereinafter referred to as VA-LCD) comprising the same. More particularly, the present invention relates to an integrated-type polarizer having a biaxial retardation film as a protective film on one side thereof, and a VA-LCD in which the integrated-type polarizer is disposed on one side of a liquid crystal cell so as to improve viewing angles thereof at the surface-facing angle and tilt angles, thereby simplifying the VA-LCD in structure as well as the fabrication process therefor.

This application claims the benefit of the filing date of Korean Patent Application Nos. 10-2005-0049325, filed on Jun. 9, 2005, in the Korean Intellectual Property Office, the disclosure of which is incorporated herein in its entirety by reference.

### BACKGROUND ART

Iodine-type polarizing films, which are most widely used in displays such as LCDs, are generally prepared by impregnating polyvinyl alcohol-based films, comprising a polyvinyl alcohol-based polymer as a principal component, with an aqueous solution of iodine-potassium iodide, and stretching and aligning them.

Because the polarization ability of such an iodine-type polarizing film deteriorates in the presence of to water or heat, the iodine-type polarizing film is provided with a protective film on each side thereof. That is, a polarizer comprises two protective films provided on both sides of a polarizing film as fundamental constitutions.

Generally, two protective films laminated on both sides of a polarizing film are substantially identical with respect to the type of polymer consisting of the films, the thickness and the physical properties. Recently, it has been required that the protective films be endowed with functionalities including optical compensability, retardation function and controllability thereof, and an anti-glare function. To satisfy the requirement, the two protective films on respective sides of the polarizing film may be different with respect to thickness, physical properties, etc. from each other.

As a polarizing film, a polyvinyl alcohol-based film is widely used while the protective films thereof are usually made from cellulose acylate, such as cellulose acetate, on account of its low birefringence, transparency and convenient handling. For example, a cellulose acylate film shows superb transparency, suitable moisture permeability, and high mechanical strength.

There are two causes of a decrease in the viewing angle of a VA-LCD comprising a polarizer having two protective films laminated on respective sides thereof: a first cause is the dependency on the viewing angle of the orthogonal polarizers, and the other is the dependency on the viewing angle of the birefringent characteristics of the VA-LCD panel.

In order to improve the viewing angle of a VA-LCD, an A-plate and/or a C-plate, each serving as a compensation film or a retardation film, is disposed between a polarizer and a liquid crystal cell. In order to compensate for the retardation characteristics at the liquid crystal cell optically serving as a +C-film (nₓ=n_{y}<n_{z}), typically, a VA-LCD has the two retardations films +A-plate and −C-plate, disposed between a polarizer and the liquid crystal cell.

In an effort to simplify the lamination structure of compensation films so as to reduce the fabrication processes thereof, a structure employing only one compensation film is disclosed in U.S. Pat. No. 4,889,412, which provides a VA-LCD comprising a −C-plate compensating film in which the −C-plate mainly serves to compensate for the black state of VA-LCD when no electric field is applied. However, because perfect compensation is not achieved in the VA-LCD provided with the −C-plate compensating film alone, light leakage occurs at tilt angles.

Also, JP 200326870 discloses an LCD structure employing only one biaxial retardation film as a viewing angle compensating film, in which, as shown in FIG. 1, a biaxial retardation film 4 is inserted between a polarizer 11 consisting of a polarizing film 11a and an inner protective film (TAC film) 11b, and an adjacent liquid crystal cell 6 so as to compensate for viewing angles. However, the minimum contrast ratio is as low as 11:1 at a tilt angle of 75° in a black state.

A VA-LCD using both a −C-plate and a +A-plate as viewing angle compensation films is disclosed in U.S. Pat. No. 6,141,075. Two sheets of viewing angle compensation films can achieve a better compensation effect than one sheet of viewing angle compensation film can, but it makes the lamination structure and the fabrication processes of the VA-LCD more complicated. In addition, the minimum contrast ratio that can be obtained by the use of two sheets of compensation films cannot exceed 16:1.

Therefore, there is a need for a VA-LCD using only one retardation film, which has the simple lamination structure and is able to be fabricated in a simple manner and at low cost. Also, there is a need for a VA-LCD having comparative superiority in terms of optical property and cost when compared with a VA-LCD using a −C-plate, and showing optical properties identical or superior to those of conventional VA-LCD using two retardation films.

### DISCLOSURE

### Technical Problem

Accordingly, the present invention has been made keeping in mind the above problems occurring in the prior art, and an object of the present invention is to provide an integrated-type polarizer which can serve as an optical compensation film as well as a polarizer.

Another object of the present invention is to provide a VA-LCD which uses the integrated-type polarizer so that it can be fabricated in a simple manner at a low cost and show identical or superior contrast properties compared to those of conventional VA-LCDs.

### TECHNICAL SOLUTION

In accordance with an aspect of the present invention, provided is an integrated-type polarizer which comprises a polarizing film and a biaxial retardation film provided on a first side of the polarizing film as a protective film, wherein the polarizing film has an absorption axis perpendicular to the optical axis of the biaxial retardation film. Preferably, the integrated-type polarizer may be for use in a vertically aligned liquid crystal display.

In accordance with another aspect of the present invention, provided is a vertically aligned liquid crystal display which comprises a liquid crystal cell filled with liquid crystal molecules of negative dielectric anisotropy between a first polarizer and a second polarizer, the respective absorption axes of which are perpendicular to each other, wherein the first polarizer is an integrated-type polarizer that includes a polarizing film and a biaxial retardation film provided on a first side of the polarizing film adjacent to a liquid crystal cell as an inner protective film, the polarizing film having an absorption axis perpendicular to an optical axis of the biaxial retardation film.

In the vertically aligned liquid crystal display, the second polarizer may be an integrated-type polarizer that includes a polarizing film and a biaxial retardation film provided on a first side of the polarizing film adjacent to the liquid crystal cell as an inner protective film, the polarizing film having an absorption axis perpendicular to an optical axis of said biaxial retardation film.

Below, a detailed description is given of the present invention with reference to the accompanying drawings.

The integrated-type polarizer according to the present invention is characterized by comprising a polarizing film and a biaxial retardation film provided on a first side of the polarizing film as a protective film, wherein the absorption axis of the polarizing film is perpendicular to the optical axis of the biaxial retardation film.

A polyvinyl alcohol (PVA) film with iodide or dichroic dye may be useful as the polarizing film. The preparation of the polarizing film may be achieved by, but is not limited to, staining a PVA film with iodide or dichroic dye. As used herein, a polarizing film not provided with a protective film will be referred to as the term of a polarizing film, while a polarizing film associated with a protective film will be referred to as the term of a polarizer.

The biaxial retardation film provided on a first side of the polarizing film as a protective film in accordance with the present invention serves not only as a protective film of the polarizing film, but also can compensate for the viewing angle of the LCD as a simple structure. Particularly, with such a structure, the integrated-type polarizer according to the present invention can achieve an optical level as high as or higher than that of a conventional polarizer using both a protective film and a viewing angle compensating film.

With reference to FIG. 2, a schematic view is provided for describing refractive indices of a retardation film used to compensate viewing angles of a VA-LCD.

When the refractive index in an x-axis direction of the in-plane refractive index is represented by nₓ, the refractive index in a y-axis direction of the in-plane refractive index is represented by n_{y}, and the refractive index in a z-axis direction as a thickness direction is represented by n_{z}, optical properties of the retardation film depend on the size of the refractive indices. When the three refractive indices of the respective axis directions differ from one another, the retardation film is called a biaxial retardation film, which can be defined as follows:

(1) when nₓ≠n_{y}>n_{z}, it is a negative (−) biaxial retardation film with Rᵢₙ, (in-plane retardation value)>0 and Rₜₕ (thickness retardation value) <0, wherein Rᵢₙ and Rₜₕ are defined by the following Math Formulas 1 and 2, respectively,
Rᵢₙ=n=d×(nₓ−n_{y}) [Math Formula 1]

(wherein d represents a film thickness)
Rₜₕ=d×(n_{g}−n_{y}) [Math Formula 2]

(wherein d represents a film thickness)

(2) when nₓ≠n_{z}>n_{y}, it is a positive (+) biaxial retardation film with Rᵢₙ>0 and Rₜₕ>0 wherein Rᵢₙ and Rₜₕ are defined by the Math Formulas 1 and 2, respectively.

The biaxial retardation film preferably has an Rᵢₙ from 40 nm to 110 nm at a wavelength of 550 nm, and an Rₜₕ from −300 nm to −180 nm at a wavelength of 550 nm.

Examples of the biaxial retardation film useful in the present invention include a stretched cycloolefin film, a stretched triacetate cellulose film, a stretched polynorbonene film, a biaxial liquid crystal film and etc.

In the integrated-type polarizer of the present invention, the polarizing film having the biaxial retardation film on the first side thereof as a protective film is preferably provided with a protective film on a second side opposite of the first side. A film with zero or a negative thickness retardation value can be used as the protective film. Alternatively, the protective film provided on the second side of the polarizing film may be the same as the biaxial retardation film provided on the first side of the polarizing film. The polarizing film may be provided with two identical or different films on respective sides thereof.

Illustrative, non-limiting examples of the protective film applied to the second side of the polarizing film include a triacetate cellulose (TAC) film, an ROMP (ring opening metathesis polymerization) polynorbornene-based film, an TROMP (ring opening metathesis polymerization followed by hydrogenation) polymer film, which is obtained by hydrogenating a ring opening metathesis polymerized cycloolefine-based polymer, a polyester film, an addition polymerization polynorbornene-based film, etc. In addition, a film made from a transparent polymer may be available as the protective film.

To produce the integrated-type polarizer of the present invention, the protective film and the polarizing film may be laminated using a method known in the art.

For instance, the protective film and the polarizing film can be bonded to each other using an adhesive. In detail, an adhesive is applied on a protective film or a polarizing film made of PVA using a roll coater, a gravure coater, a bar coater, a knife coater, or a capillary coater. Before the adhesive is completely dried. The protective film and the polarizing film are pressed against each other, at a high temperature or at room temperature, using a laminating roll. When using a hot-melt adhesive, a hot pressing roll is required.

Examples of the adhesive useful for the lamination of the protective film and the polarizing film include, but are not limited to, one- or two-part PVA adhesives, polyurethane-based adhesives, epoxy-based adhesives, styrene-butadiene-rubber (SBR)-based adhesives, and hot-melt type adhesives. When a polyurethane-based adhesive is used, it is preferably prepared from an aliphatic isocyanate-based compound which does not undergo yellowing by light. In the case where a one- or two-part adhesive for dry lamination or an adhesive with relatively low reactivity between isocyanate and hydroxy is used, it may be a solution adhesive in which an acetate solvent, a ketone solvent, an ether solvent, or an aromatic solvent is used as a diluent. This adhesive preferably has a low viscosity of 5000 cps or less. The adhesive useful in the present invention is required to have excellent storage stability and a light transmissivity of 90% or higher at 400-800 nm.

If showing sufficient tackifying power, a tackifier may be used for the lamination of the protective film and the polarizing film. If used, a tackifier is preferably heat- or UV-cured sufficiently to show resulting mechanical strength as high as that obtained with an adhesive. Also, the interface adhesion of the tackifier useful in the present invention is large enough so that delamination is possible only when one of the films bonded to each other therethrough is destroyed.

Examples of the tackifier useful in the present invention include tackifiers made from highly optically transparent natural rubber, synthetic rubber or elastomers, vinyl chloride/vinyl acetate copolymers, polyvinylalkyl ether, polyacrylate, or modified polyolefin, and curable tackifiers prepared by the addition of curing agents such as isocyanate to the above materials.

When the integrated-type polarizer according to the present invention is applied to a VA-LCD, the biaxial retardation film, serving as a film that protects the polarizer, can compensate for the retardation attributable to the birefringence of the liquid crystal layer at high efficiency.

In accordance with another aspect of the present invention, a VA-LCD comprising the integrated-type polarizer is provided. In detail, the VA-LCD according to the present invention comprises a first polarizer and a second polarizer, the respective absorption axes of which are perpendicular to each other, with a liquid crystal cell filled with liquid crystal molecules of negative dielectric anisotropy being disposed therebetween, wherein the first polarizer is an integrated-type polarizer including a polarizing film and a biaxial retardation film provided on a first side of the polarizing film adjacent to a liquid crystal cell as an inner protective film, said biaxial retardation film having an optical axis perpendicular to the absorption axis of the polarizing film.

As described above, the LCD of the present invention is a VA-LCD in which the optical axis of the liquid crystal molecules in the liquid crystal cell is vertical to the polarizer. As seen in figures, the VA-LCD of the present invention includes a first polarizer 11, a vertically aligned liquid crystal cell 6 having liquid crystal molecules of negative dielectric anisotropy (Δε<0) confined between two plates, and a second polarizer 12, wherein the absorption axis 3 of the first polarizer is perpendicular to that 9 of the second polarizer.

In the VA-LCD, the liquid crystal cell preferably has a refractive index meeting the relationship nₓ≈n_{y}<n_{z} when it is in an ON or OFF state. For the liquid crystal cell, an MVA (multi-domain vertically aligned) mode, wherein ridges including a pair of electrodes positioned on the first and the second substrate are constructed on the surface adjacent to the liquid crystal layer, forming a multi-domain structure, a PVA (patterned vertically aligned) mode, in which electrodes are patterned so as to form a multi-domain structure upon the application of a voltage, or a VA (vertically aligned) mode, in which a chiral additive is used, can be applied. The liquid crystal cell preferably has a cell gap from 2.5 to 8 μm.

A white state of the VA-LCD is displayed when, in the presence of orthogonal polarizers, after the light incident from a backlight is linearly polarized at an angle of 0°, it passes through the liquid crystal layer to be 90°-rotated linearly polarized and transmitted. The conversion of 0°-rotated, linearly polarized light into 90°-rotated linearly polarized light is possible when the retardation value of the liquid crystal cell is half of the wavelength of the incident light.

The biaxial retardation film provided on the first side of the polarizing film of the first polarizer as an inner protective film is a negative (−) biaxial retardation film with Rᵢₙ>0 and Rₜₕ<0 or a positive (+) biaxial retardation film with Rᵢₙ>0 and Rₜₕ>0.

Preferably, the biaxial retardation film ranges in in-plane retardation value from 40 nm to 110 nm at a wavelength of 550 nm and in thickness retardation value from −300 nm to −180 nm at a wavelength of 550 nm.

Examples of the biaxial retardation film useful in the present invention include a stretched cycloolefin film, a stretched triacetate cellulose film, a stretched polynorbonene film, and a biaxial liquid crystal film.

In the VA-LCD of the present invention, respective protective films may be preferably provided at a second side of the polarizing film of the first polarizer, opposite of the first side adjacent to the liquid crystal layer, and at both sides of the polarizing film of the second polarizer, that is, on a first side adjacent to the liquid crystal layer, and on a second side opposite of the first side. A film with zero or a negative thickness retardation value can be used as the protective film. Alternatively, the protective films provided on the second side of the polarizing film of the first polarizer and on the first and the second side of the polarizing film of the second polarizer may be the sane as the biaxial retardation film provided on the first side of the polarizing film of the first polarizer. The protective films used on respective sides of the polarizing films may be the same or different.

Illustrative, non-limiting examples of the protective film applied to the second side of the polarizing film of the first polarizer and to the first and the second side of the polarizing film of the second polarizer include a triacetate cellulose (TAC) film, an ROMP (ring opening metathesis polymerization) polynorbornene-based film, an HROMP (ring opening metathesis polymerization followed by hydrogenation) polymer film, which is obtained by hydrogenating a ring opening metathesis polymerized cycloolefine-based polymer, a polyester film, and an addition polymerization polynorbornene-based film. In addition, a film made from a transparent polymer may be available as the protective film.

Particularly, as the protective film provided on the first side of the polarizing film of the second polarizer, which is adjacent to the liquid crystal layer, that is, the inner protective film of the second polarizer, films with the thickness retardation value of −60 to 0, more preferably 0, are preferred. For example, films made from unstretched cycloolefin, unstretched triacetate cellulose or unstretched polynorbornene are preferred. The use of such films as the inner protective film of the second polarizer in combination with the [symbol] achieve optical properties superior to those obtainable from other combinations.

In the VA-LCD of the present invention, if the second polarizer is an integrated-type polarizer including a polarizing film and a biaxial retardation film provided on a first side of the polarizing film adjacent to a liquid crystal cell as an inner protective film, the optical axis of the biaxial retardation film is preferably perpendicular to the absorption axis of the polarizing film.

In the LCD of the present invention, a backlight source may be provided near the first polarizer or the second polarizer.

With reference to FIG. 3, a VA-LCD structure according to a first embodiment of the present invention is shown, in which a biaxial retardation film 4 is used as an inner protective film of a first polarizer 11. As shown in this figure, the biaxial retardation film 4 is placed between a polarizing PVA film 2 of the first polarizer 11 and a VA liquid crystal cell 6 and has an optical axis 5 perpendicular to the absorption axis 3 of the polarizing PVA film of the first polarizer. In this structure, a backlight source is positioned near a second polarizer 12 while a viewer is near the first polarizer 11.

FIG. 4 shows a VA-LCD structure according to a second embodiment of the present invention, in which a biaxial retardation film 4 is placed between a polarizing PVA film 2 of a first polarizer 11 and a VA liquid crystal cell 6, and has an optical axis 5 perpendicular to the absorption axis 3 of the polarizing film of the first polarizer. In this structure, a backlight source is positioned near the first polarizer 11 while a viewer is near the second polarizer 12.

### ADVANTAGEOUS EFFECTS

Featuring the employment of a biaxial retardation film as an inner protective film of the first polarizer, the VA-LCD according to the present invention has a viewing angle compensating properties identical or superior to those of the conventional VA-LCD, and is able to be fabricated in a simple manner due to its simplified structure so as to have price competitiveness when compared with the conventional VA-LCD structure.

### DESCRIPTION OF DRAWINGS

FIG. 1 is a schematic cross sectional view showing the structure of a conventional VA-LCD using a biaxial retardation film as a compensation film.

FIG. 2 is a view showing refractive indices of a retardation film.

FIG. 3 is a schematic view showing the structure of a VA-LCD in accordance with a first embodiment of the present invention.

FIG. 4 is a schematic view showing the structure of a VA-LCD in accordance with a second embodiment of the present invention.

FIG. 5 is a schematic view showing the structure of a VA-LCD in accordance with Comparative Example 1.

FIG. 6 is a schematic view showing the structure of a VA-LCD in accordance with Comparative Example 2.

FIG. 7 is a view showing simulation results for the contrast ratio of the VA-LCD according to the first embodiment of the present invention at tilt angles from 0 to 80° with respect to entire radius angles when white light is used.

FIG. 8 is a view showing simulation results for the contrast ratio of the VA-LCD according to the second embodiment of the present invention at tilt angles from 0° to 80° with respect to entire radius angles when white light is used.

FIG. 9 is a view showing simulation results for the contrast ratio of the VA-LCD according to Comparative Example 1 at tilt angles from 0° to 80° with respect to entire radius angles when white light is used.

FIG. 10 is a view showing simulation results for the contrast ratio of the VA-LCD according to Comparative Example 2 at tilt angles from 0° to 80° with respect to entire radius angles when white light is used.

FIG. 11 is a view showing simulation results for the contrast ratio of the VA-LCD according to Example 3 at tilt angles from 0° to 80° with respect to entire radius angles when white light is used.

FIG. 12 is a view showing simulation results for the contrast ratio of the VA-LCD according to Example 4 at tilt angles from 0° to 80° with respect to entire radius angles when white light is used.

FIG. 13 is a view showing simulation results for the contrast ratio of the VA-LCD according to Example 5 at tilt angles from 0° to 80° with respect to entire radius angles when white light is used.

FIG. 14 is a view showing the contrast ratio in the VA-LCD structure of Example 4, Example 6 and Example 7.

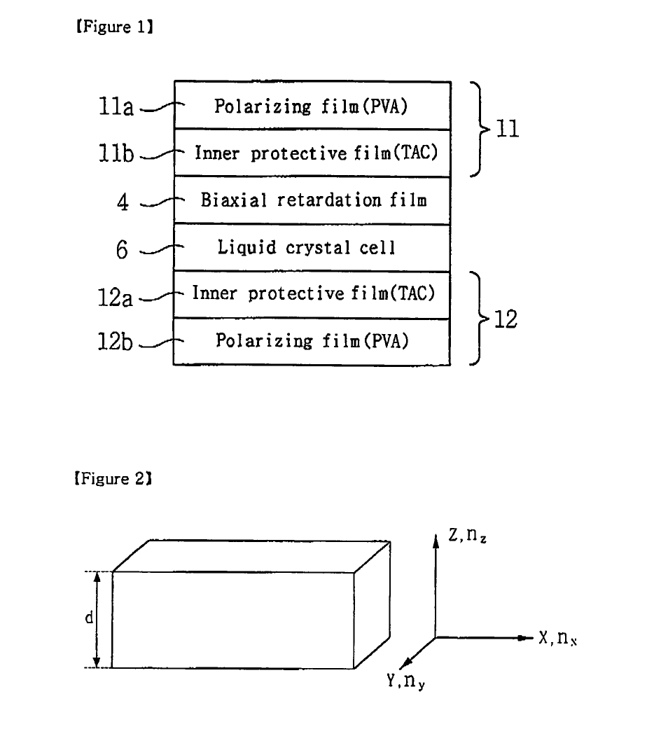

(1: outer protective film, 2: PVA(polyvinyl alcohol), 4: biaxial retardation film, 6: liquid crystal cell, 7: inner protective film, 8: PVA, 10: outer protective film. 11: first polarizer, 11a: polarizing film, 11b: TAC(triacetyl cellulose) film, 12: second polarizer, 12a: polarizing film, 12b: TAC film, 15: A-plate)

### MODE FOR INVENTION

A better understanding of the present invention may be obtained through the following examples which are set forth to illustrate, but are not to be construed as the limit of the present invention.

### EXAMPLE 1

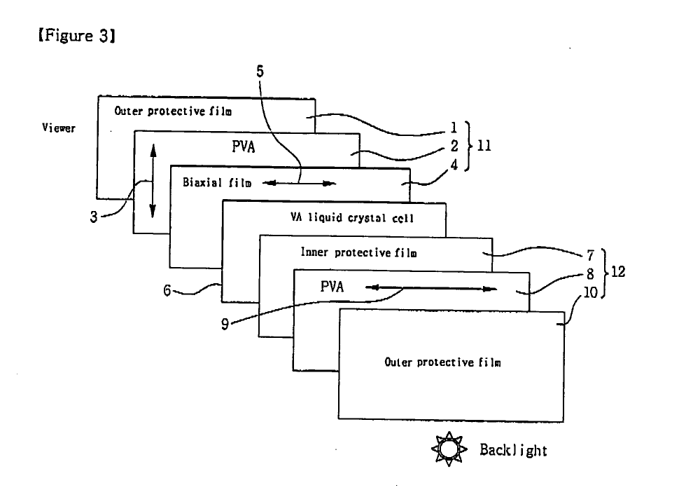

In the structure of the first embodiment shown in FIG. 3, the VA liquid crystal cell 6 had a cell gap of 2.9 μm and a pretilt angle of 89° and was filled with liquid crystal molecules having a dielectric anisotropy (Δε) of −4.9 and a birefringence (en) of 0.099.

The biaxial retardation film 4, also serving as the inner protective film of the first polarizer 11, was made from a COP (cyclo-olefin polymer) film 80 μm thick, whose in-plane retardation value (Rᵢₙ) and thickness retardation value (Rₜₕ) were given in Table 1, below.

As for the inner protective film 7 of the second polarizer 12, it was made from a TAC (triacetate cellulose) film 80 μm thick having a thickness retardation value of −56 nm or a TAC film 50 μm thick having a thickness retardation value of −30 nm.

Outer protective films of the first and second polarizer were the same film as their inner protective films, respectively.

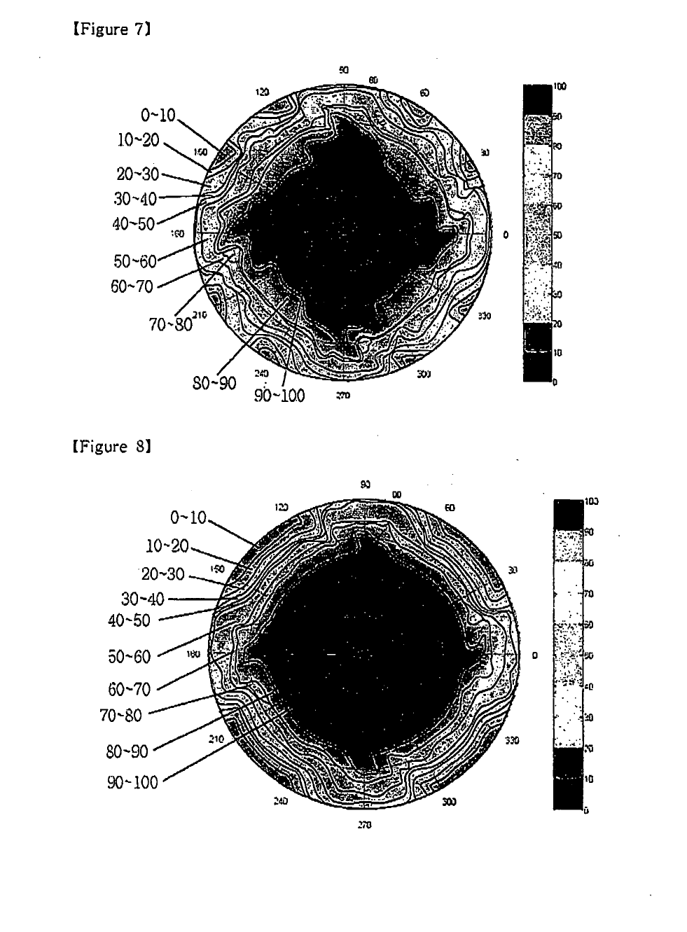

Contrast properties were measured at tilt angles from 0° to 80° with respect to entire radius angles when white light was used, and are given in Table 1, and FIG. 7.

As seen in FIG. 7, the contrast ratio was measured to be 25:1 at a tilt angle of 75°, which is as large as or larger than the contrast ratio obtainable from conventional LCDs.

TABLE 1

| | | Inner | |
|---|---|---|---|
| Biaxial | Retardation | Protective Film | Minimum Contrast |
| Retardation | of VA Liquid | of Second | Ratio at Tilt |
| Film (Rᵢₙ, Rₜₕ) | Crystal Cell | Polarizer | Angle of 75° |
| (40, −250) | 332 nm | 80 μm TAC | 24 |
| (50, −220) | | | 21 |
| (60, −220) | | | 23 |
| (40, −260) | | 50 μm TAC | 22 |
| (60, −240) | | | 22 |
| (70, −250) | | | 25 |

### EXAMPLE 2

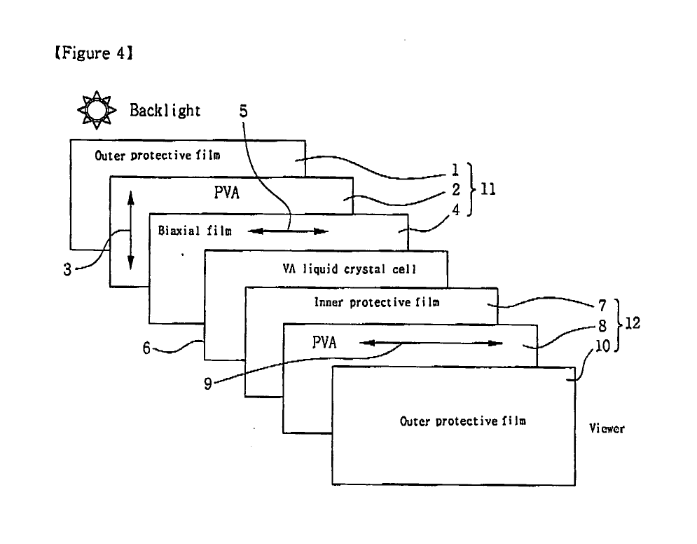

In the structure of the second embodiment shown in FIG. 4, the VA liquid crystal cell 6 had a cell gap of 2.9 μm and a pretilt angle of 89° and was filled with liquid crystal molecules having a dielectric anisotropy (Δε) of −4.9 and a birefringence (Δn) of 0.099.

The biaxial retardation film 4, also serving as the inner protective film of the first polarizer 11, was made from a COP (cyclo-olefin polymer) film having an in-plane retardation value (Rᵢₙ) of 60 nm and a thickness retardation value (Rₜₕ) of −220 nm. As the inner protective film 7 of the second polarizer 12, a TAC (triacetate cellulose) film 80 μm thick was used.

Outer protective films of the first and second polarizer were the same film as their inner protective films, respectively.

Contrast properties were measured at tilt angles from 0° to 80° with respect to entire radius angles when white light was used, and are shown in FIG. 8.

As seen in FIG. 8, the contrast ratio was measured to be 23:1 at a tilt angle of 75°.

### COMPARATIVE EXAMPLE 1

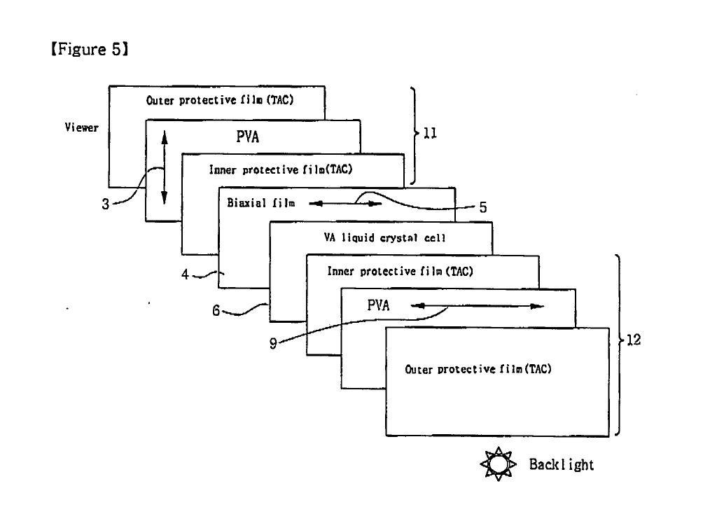

FIG. 5 shows a conventional structure given for comparison with that of Example 1 or 2. As can be seen, the conventional VA-LCD comprises a first polarizer 11 and a second polarizer 12 having respective inner protective films provided therefor, wherein a biaxial retardation film 4 is placed between the first polarizer 11 and a VA liquid crystal cell 6. The VA liquid crystal cell was the same as was used in Example 1 or 2. That is, the VA-panel was comprised of the VA liquid crystal cell 6 having a cell gap of 2.9 μm and a pretilt angle of 89°, and was filled with liquid crystal molecules having a dielectric anisotropy (Δε) of −4.9 and a birefringence (Δn) of 0.099.

The biaxial retardation film 4 adjacent to the first polarizer 11 had an in-plane retardation value (Rᵢₙ) of 60 nm and a thickness retardation value (Rₜₕ) of −190 nm. All of the respective inner and outer protective films for the first polarizer 11 and the second polarizer 12 were made from a TAC (triacetate cellulose) film 80 μm thick having a thickness retardation value of −56 nm.

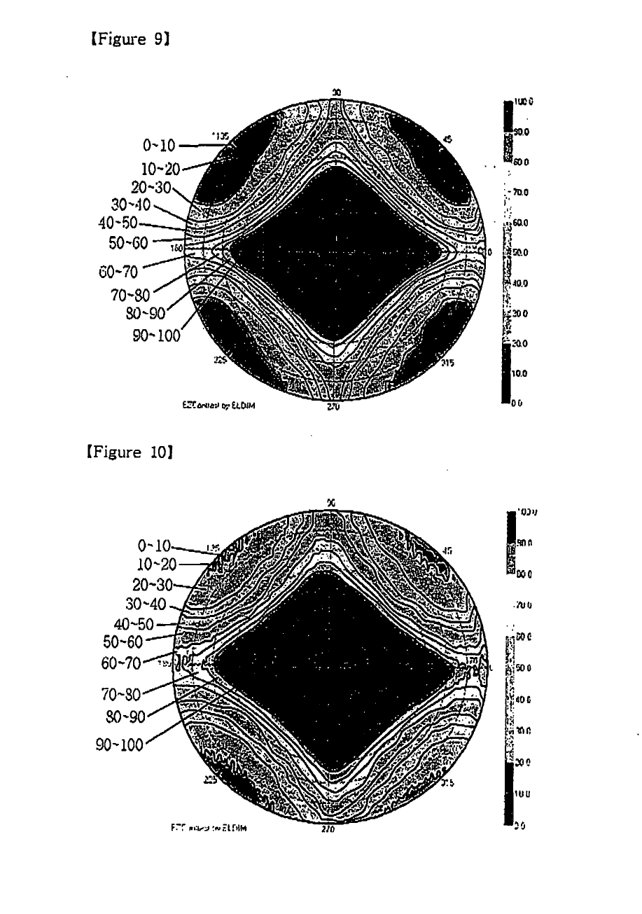

Contrast properties were measured at tilt angles from 0° to 80° with respect to entire radius angles when white light was used, and are given in FIG. 9.

[symbol]

TAC film as an inner protective film of the first polarizer 11 with the biaxial retardation film 4 inserted between the liquid crystal cell 6 and the first polarizer 11 was measured to be as low as 11:1 at a tilt angle of 75°.

### COMPARATIVE EXAMPLE 2

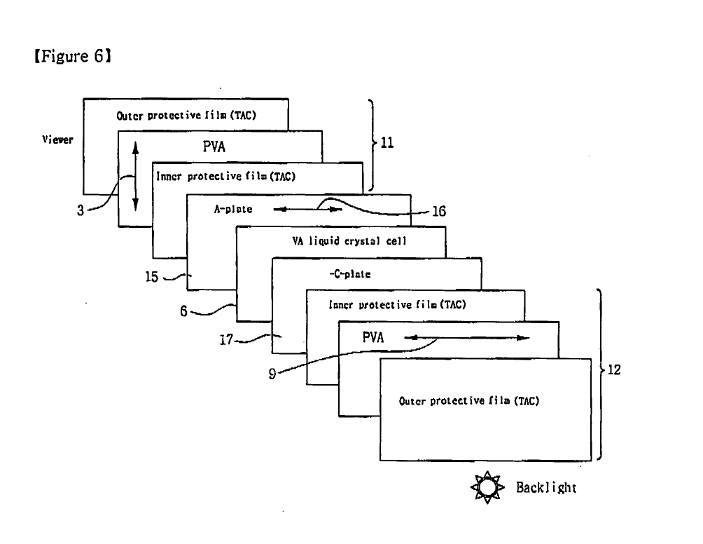

The VA-LCD structure used in this comparative example is shown in FIG. 6, and comprises a first polarizer 11 and a second polarizer 12 with respective inner films provided therefor, and a VA liquid crystal cell 6 positioned between the first polarizer and the second polarizer, wherein an A-plate 15 and a C-plate 17 are placed between the first polarizer and the VA liquid crystal cell 6 and between the second polarizer and the VA liquid crystal cell 6, respectively. The VA-panel 6 was comprised of a VA liquid crystal cell having a cell gap of 2.9 μl and a pretilt angle of 89°, and was filled with liquid crystal molecules having a dielectric anisotropy (Δε) of −4.9 and a birefringence (Δn) of 0.099.

The −C-plate 17 adjacent to the second polarizer 12 was a liquid crystal film having a thickness retardation value (Rₜₕ) of −165 nm at a wavelength of 550 nm. The A-plate 15 adjacent to the first polarizer 11 had an in-plane retardation value (Rᵢₙ) of 90 nm. All of the respective inner and outer protective films of the first polarizer 11 and the second polarizer 12 were made of a TAC film 80 μm thick having a thickness retardation value of −56 nm.

Contrast properties were measured at tilt angles from 0 to 80° with respect to entire radius angles when white light was used, and are given in FIG. 10. As seen in FIG. 10, the contrast ratio was measured to be as low as 16:1 at a tilt angle of 75°.

### EXAMPLES 3 To 7

In a liquid crystal display comprising a vertically aligned liquid crystal cell between a first polarizer and a second polarizer, the respective absorption axes of which are perpendicular to each other, and backlight source positioned near the second polarizer, the contrast properties according to the different kinds of inner protective films of the polarizers at tilt angles of 75′ are given in the following Table 2.

The VA-panel was comprised of a VA liquid crystal cell having a cell gap of 2.9 μm and a pretilt angle of 89°, and was filled with liquid crystal molecules having a dielectric anisotropy (Δε) of −4.9 and a birefringence (Δn) of 0.099. Outer protective films of the first and second polarizer were the same film as their inner protective films, respectively.

TABLE 2

| | | Retardation | | Minimum Contrast |
|---|---|---|---|---|
| Example | Inner Protective Film of | of VA Liquid | Inner Protective Film | Ratio at Tilt |
| No. | First Polarizer | Crystal Cell | of Second Polarizer | Angle of 75° |
| Ex. 3 | biaxial COP film | 332 nm | 80 μm − thick TAC film | 15 |
| | (Rᵢₙ = 70 nm, Rₜₕ = −185 nm) | | (Rₜₕ = −56 nm) | |
| Ex. 4 | 80 μm − thick TAC film | 332 nm | biaxial COP film | 23 |
| | (Rₜₕ = −56 nm) | | (Rᵢₙ = 70 nm, Rₜₕ = −185 nm) | |
| Ex. 5 | biaxial COP film | 332 nm | biaxial COP film | 21 |
| | (Rᵢₙ = 50 nm, Rₜₕ = −130 nm) | | (Rᵢₙ = 50 nm, Rₜₕ = −130 nm) | |
| Ex. 6 | 50 μm − thick TAC film | 332 nm | biaxial COP film | 24 |
| | (Rₜₕ = −30 nm) | | (Rᵢₙ = 70 nm, Rₜₕ = −215 nm) | |
| Ex. 7 | unstreched COP film | 332 nm | biaxial COP film | 28 |
| | (Rₜₕ = −0 nm) | | (Rᵢₙ = 70 nm, Rₜₕ = −250 nm) | |

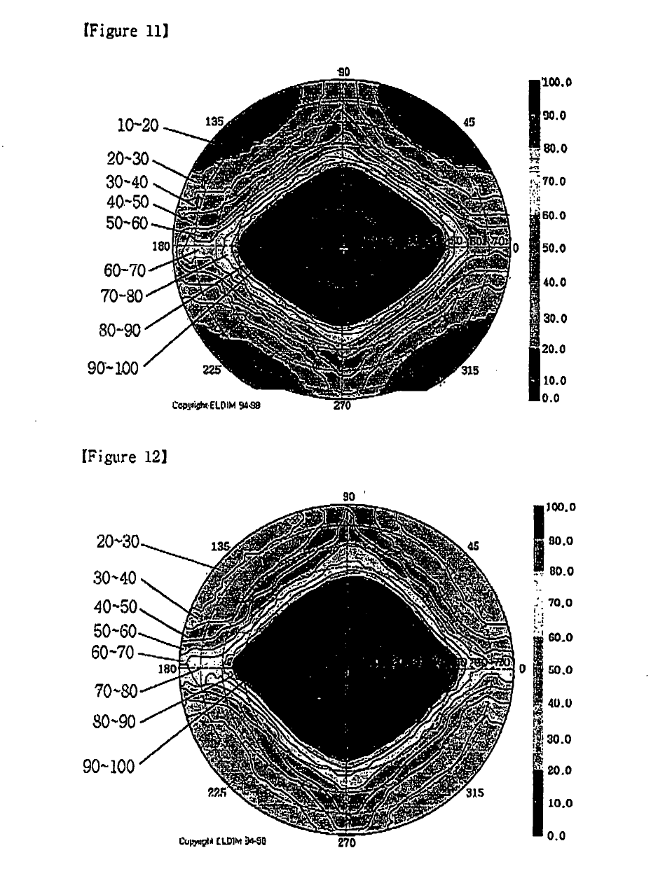

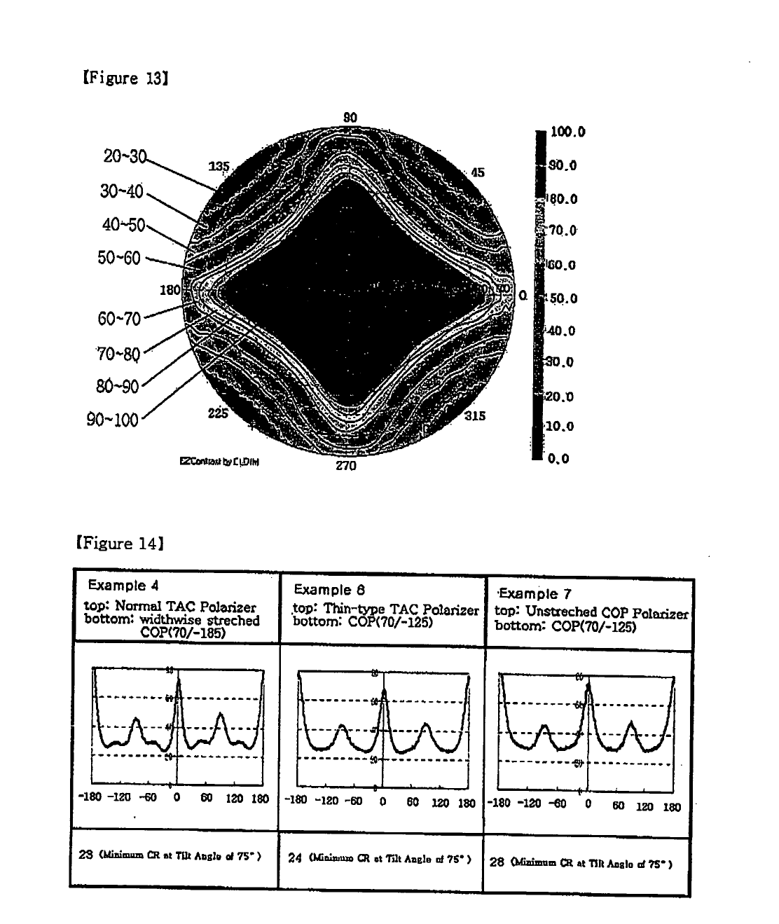

In the Examples 3 to 5, the contrast properties according to the position of the integrated-type polarizer were measured. FIGS. 11 to 13 show the contrast properties of the VA-LCD according to Examples 3 to 5 at tilt angles from 0 to 80° with respect to entire radius angles when white light is used, respectively.

FIG. 14 shows the contrast ratio properties of the VA-LCD of Example 4, Example 6 and Example 7 at tilt angles of 75° with respect to entire radius angles. The contrast ratio properties vary according to the viewing direction of the radius angles. Since the minimum contrast ratio is the contrast ratio at an angle where the viewing properties are most poor among the entire radius angles, the better the minimum contrast ratio, the better the viewing properties. As showned at FIG. 14, when the biaxial film was used as the inner protective film of one polarizer and the film with the thickness retardation value of 0 was used as the inner protective film of the other polarizer. VA-LCD performed most effectively.

1. An integrated-type polarizer, comprising a polarizing film and a biaxial retardation film provided on a first side of the polarizing film as a protective film, wherein the polarizing film has an absorption axis perpendicular to the optical axis of the biaxial retardation film.

2. The integrated-type polarizer according to claim 1, wherein the polarizing film is a polyvinyl alcohol (PVA) film stained with iodide or a dichroic dye.

3. The integrated-type polarizer according to claim 1, wherein the biaxial retardation film has an in-plane retardation value from 40 nm to 110 nm and a thickness retardation value from −300 nm to −180 nm when a wavelength of 550 nm is used.

4. The integrated-type polarizer according to claim 1, wherein the biaxial retardation film is selected from a group consisting of a stretched cycloolefin film, a stretched triacetate cellulose film, a stretched polynorbornene film and a biaxial liquid crystal film.

5. The integrated-type polarizer according to claim 1, wherein the polarizing film and the biaxial retardation film are bonded to each other using an adhesive or a tackifier.

6. The integrated-type polarizer according to claim 1, wherein the polarizing film is further provided with a protective film on a second side opposite of the first side thereof.

7. The integrated-type polarizer according to claim 6, wherein the protective film provided on the second side of the polarizing film is a film having zero thickness retardation value or a negative thickness retardation value, or a biaxial retardation film.

8. The integrated-type polarizer according to claim 6, wherein the protective film provided on the second side of the polarizing film is selected from a group consisting of a triacetate cellulose (TAC) film, a ring opening metathesis polymerization (ROMP) polynorbonene-based film, a ring opening metathesis polymerization followed by hydrogenation (TROMP) polymer film, which is obtained by hydrogenating a ring opening metathesis polymerized cycloolefine-based polymer, a polyester film and an addition polymerization polynorbonene-based film.

9. The integrated-type polarizer according to claim 1, wherein the integrated-type polarizer is for use in a vertically aligned liquid crystal display.

10. A vertically aligned liquid crystal display, comprising a liquid crystal cell filled with liquid crystal molecules of negative dielectric anisotropy between a first polarizer and a second polarizer, said first polarizer having an absorption axis perpendicular to that of said second polarizer, wherein the first polarizer is an integrated-type polarizer that includes a polarizing film and a biaxial retardation film provided on a first side of the polarizing film adjacent to a liquid crystal cell as an inner protective film, said polarizing film having an absorption axis perpendicular to an optical axis of said biaxial retardation film.

11. The vertically aligned liquid crystal display according to claim 10, wherein the polarizing film of the first polarizer is a polyvinyl alcohol (PVA) film stained with iodide or dichroic dye.

12. The vertically aligned liquid crystal display according to claim 10, wherein the biaxial retardation film has an in-plane retardation value from 40 nm to 110 nm and a thickness retardation value from −300 nm to −180 nm when a wavelength of 550 nm is used.

13. The vertically aligned liquid crystal display according to claim 10, wherein the biaxial retardation film is selected from a group consisting of a stretched cycloolefin film, a stretched triacetate cellulose film, a stretched polynorbornene film and a biaxial liquid crystal film.

14. The vertically aligned liquid crystal display according to claim 10, wherein a protective film is provided on at least one side among a second side of the polarizing film of the first polarizer, opposite of the first side adjacent to the liquid crystal cell, a first side of the polarizing film of the second polarizer, adjacent to the liquid crystal cell, and a second side opposite of the first side of the polarizing film of the second polarizer.

15. The vertically aligned liquid crystal display according to claim 14, wherein the protective film, provided on at least one side among a second side of the polarizing film of the first polarizer, opposite of the first side adjacent to the liquid crystal cell, a first side of the polarizing film of the second polarizer, adjacent to the liquid crystal cell, and a second side opposite of the first side of the polarizing film of the second polarizer, is a film having zero thickness retardation value or a negative thickness retardation value, or a biaxial retardation film.

16. The vertically aligned liquid crystal display according to claim 14, wherein the protective film, provided on at least one side among a second side of the polarizing film of the first polarizer, opposite of the first side adjacent to the liquid crystal cell, a first side of the polarizing film of the second polarizer, adjacent to the liquid crystal cell, and a second side opposite of the first side of the polarizing film of the second polarizer, is selected from a group consisting of a triacetate cellulose (TAC) film, a ring opening metathesis polymerization (ROMP) polynorbonene-based film, a ring opening metathesis polymerization followed by hydrogenation (HROMP) polymer film, which is obtained by hydrogenating a ring opening metathesis polymerized cycloolefine-based polymer, a polyester film, and an addition polymerization polynorbonene-based film.

17. The vertically aligned liquid crystal display according to claim 10, wherein the second polarizer includes a polarizing film provided with a protective film on a first side thereof adjacent to the liquid crystal cell, said protective film being a film with thickness retardation value of −60 to 0.

18. The vertically aligned liquid crystal display according to claim 10, wherein the second polarizer includes a polarizing film provided with a protective film on a first side thereof adjacent to the liquid crystal cell, said protective film being a film with thickness retardation value of 0.

19. The vertically aligned liquid crystal display according to claim 10, wherein the second polarizer includes a polarizing film provided with a protective film on a first side thereof adjacent to the liquid crystal cell, said protective film being selected from a group consisting of an unstretched cycloolefin film, an unstretched triacetate cellulose film, and an unstretched polynorbornene film.

20. The vertically aligned liquid crystal display according to claim 10, wherein the second polarizer is an integrated-type polarizer that includes a polarizing film and a biaxial retardation film provided as an inner protective film on a first side of the polarizing film adjacent to the liquid crystal cell, said polarizing film having an absorption axis perpendicular to an optical axis of said biaxial retardation film.

21. The vertically aligned liquid crystal display according to claim 10, wherein the vertically aligned liquid crystal display is in a multi-domain vertically aligned (MVA) mode, a patterned vertically aligned (PVA) mode, or a vertically aligned (VA) mode using a chiral additive, and the liquid crystal cell has a cell gap ranging from 2.5 to 8 μm.

22. The vertically aligned liquid crystal display according to claim 10, wherein a backlight source is provided near the first or the second polarizer.
